(19) United States
(12) Patent Application Publication
(10) Pub. No.: US 2020/0155875 A1
(43) Pub. Date: May 21, 2020

(54) Intelligent Rope Descending Rescue Backpack

(71) Applicant: Siu Tsuen MAK, Hong Kong (HK)

(72) Inventor: Siu Tsuen MAK, Hong Kong (HK)

(21) Appl. No.: 16/236,615

(22) Filed: Dec. 30, 2018

(30) Foreign Application Priority Data
Nov. 19, 2018 (CN) 201811378487.1

(51) Int. Cl. A62B 1/14; A62B 35/00; A62B 35/04

(52) U.S. Cl. CPC A62B 1/14; A62B 35/04; A62B 35/0025

(57) ABSTRACT

The invention relates to an intelligent rope descending rescue backpack which includes a backpack body, a descending device, a controller and an alarm. The backpack body includes an upper body, a lower body, a backpack belt, a telescopic belt, and a V-belt. The upper body is provided with a zipper. The lower body is provided with a telescopic device. The telescopic belt is connected to the telescopic device. The descending device includes a roller shaft, a speed reducing mechanism and an annular safety bucket. The speed descending mechanism includes a second bracket, a damper shaft, a locking shaft and a locking mechanism. The alarm includes a third bracket, a third housing, a hook, a ship type switch, an alarm, a speaker and a second battery. The intelligent rope descending rescue backpack has a simple and reasonable structure, easy to use, safe and reliable, highly intelligent, and easy to store, etc. which effectively solves the difficulty of escaping from high-rise buildings.

### FIELD OF THE INVENTION

The invention relates to the field of fire rescue equipment, in particular to an intelligent rope descending rescue backpack.

### BACKGROUND

At present, with the development of the society, there are more and more high-rise buildings. On the one hand, these high-rise buildings save a lot of construction land. On the other hand, the safety problems of high-rise buildings are increasingly exposed. The high-rise buildings have high floors and many people live in the buildings, but the escape route that can be used is limited. If the fire and smoke are climbing up along the corridor, the light in the escape channel is dim and full of toxic and harmful smoke. When people escape and run towards the escape route, it is easy to cause stampede and for people to inhale toxic and harmful gases which causes coma during the escape process. Escape from other exits such as window requires firefighters to operate fire-fighting equipment such as fire-fighting ladders and trucks on the ground. However, the number of personnel rescued by the fire-fighting ladders and trucks is limited and the operation speed is slow, which is difficult to meet the needs of a large number of rescue workers. Therefore, how residents living in high-rises can achieve rapid and safe escape, how to improve the effectiveness and success rate of escapes in the event of accidents, and reduce casualties has become a new topic of high-rise building safety.

### SUMMARY OF THE INVENTION

The technical problem to be solved is to overcome the above-mentioned deficiency by providing an intelligent rope descending rescue backpack which has a simple and reasonable structure, easy to use, safe and reliable, highly intelligent, and easy to store, etc. which effectively solves the difficulty of escaping from high-rise buildings.

The present solution of the present invention is to provide an intelligent rope descending rescue backpack which includes a backpack body, a descending device, a controller and an alarm. The backpack body includes an upper body, a lower body, a backpack belt, a telescopic belt and a V-belt. The upper body and the lower body are connected to each other and separated from each other. The inner cavity of the backpack body is provided with a support plate passing through the upper body and the lower body.

The upper body is provided with a zipper, and the lower body is divided into a first cavity and a second cavity. The second cavity is provided with a telescopic device. The telescopic belt is divided into two sections. One end of two sections of the telescopic belt is respectively connected with the telescopic device. The other ends of the two wound springs are respectively connected to each other through a belt buckle. The V-belt is disposed in the first cavity, and one end of the V-belt is connected with the support plate, and the other end of the V-belt extends from the first cavity and is interconnected with the belt buckle.

The descending device is disposed in the inner cavity of the upper body. The descending device includes a roller shaft which is rollingly connected to the support plate, a speed reducing mechanism and an annular safety buckle. The rope is wound around the roller shaft. The rope is wound with the speed reducing mechanism and passes through the backpack body and is connected to the annular safety buckle.

The speed reducing mechanism includes a second bracket connected to the support plate, a plurality of damper shafts disposed on the second bracket, a plurality of locking shafts rotatably coupled to the second bracket, and a locking mechanism. The locking mechanism includes a first housing, an electromagnet, a magnet fixedly coupled to the locking shaft. The electromagnet abuts against an opposite surface of the magnet.

The controller and the first battery are disposed in the inner cavity of the upper body and are connected to each other. The controller is further connected with the control pull ring disposed on the backpack belt and the help signal transmitter disposed in the upper body. The control pull ring includes a second housing, a tension sensor disposed in the second housing, and pull rings connected to each other by a spring and a tension sensor.

The alarm includes a third bracket fixedly disposed at the external, a third housing disposed on the third bracket, and a hook having a J-shaped structure disposed on the third bracket. The third housing is provided with a ship type switch. A warning light, a speaker and a second battery connected to the ship type switch are arranged in the three housing.

Further, the upper body is provided with a first buffer airbag.

Further, a second buffer airbag is fixedly disposed on the inner side of the backpack belt, and two ends of the backpack belt are respectively connected with the upper body and the telescopic belt. The middle portion of the backpack belt is provided with a horizontal fixing belt, and the horizontal fixing belt is provided with a connecting buckle.

Further, the belt buckle includes a buckle connected to the telescopic belt, and a connecting ring is fixedly disposed on the buckle.

Further, the telescopic device includes a first bracket, a roller symmetrically fixed on the first bracket, and a wound spring on the roller. The wound spring protrudes from two ends of the second cavity.

Further, the telescopic belt is divided into two sections, one ends of the two sections of the telescopic belt are respectively connected with the wound springs, and the other ends of the two wound springs are respectively connected to each other by a belt buckle.

Further, the damper shaft and the locking shaft are respectively provided with a first thread groove and a second thread groove, and the rope on the roller shaft is sequentially wound around the second thread groove and the first thread groove.

Further, the damper shaft is connected to a rotational speed sensor fixedly disposed on the second bracket.

Further, the controller is electrically connected to the electromagnet, the tension sensor and the rotational speed sensor.

The technical effect of the present invention is to provide an intelligent rope descending rescue backpack which includes a backpack body, a descending device, a controller and an alarm. The backpack body is fixed to a human body by a backpack belt, a telescopic belt, a V-belt. The descending device and a controller are disposed in the backpack body. The alarm is fixedly arranged at the external. The descending device is provided with a rope to be safely buckled. The reducing speed is controlled by the rope together with the speed reducing mechanism and the controller. It is safe and reliable. When the safety buckle is connected with the alarm, the warning light and the speaker on the alarm are automatically turned on to remind the rescuers. People's location information is sent to the rescuers by the help signal transmitter to facilitate the rescuers to look for people. The intelligent rope descending rescue backpack has a simple and reasonable structure, easy to use, safe and reliable, highly intelligent, and easy to store, etc. which effectively solves the difficulty of escaping from high-rise buildings.

### BRIEF DESCRIPTION OF THE DRAWINGS

The invention is illustrated by the following figures and embodiments.

FIG. 1 shows a schematic diagram of side structure of an intelligent rope descending rescue backpack.

FIG. 2 shows a schematic diagram of front structure of an intelligent rope descending rescue backpack.

FIG. 3 shows a schematic diagram of an alarm of an intelligent rope descending rescue backpack.

FIG. 4 shows a schematic diagram of inside structure of a backpack body of an intelligent rope descending rescue backpack.

FIG. 5 shows a schematic diagram of a pull ring of an intelligent rope descending rescue backpack.

FIG. 6 shows a schematic diagram of a belt buckle of an intelligent rope descending rescue backpack.

FIG. 7 shows a schematic diagram of a telescopic device of an intelligent rope descending rescue backpack.

FIG. 8 shows a schematic diagram of speed reducing mechanism of an intelligent rope descending rescue backpack.

FIG. 9 shows a schematic diagram of connection of a locking shaft, a locking mechanism and a second bracket of an intelligent rope descending rescue backpack.

FIG. 10 shows a schematic diagram of a damper shaft of an intelligent rope descending rescue backpack.

The reference numbers of the figures are as follows:
1: backpack body; 10: support plate; 11: upper body; 111: zipper; 112: first buffer airbag; 12: lower body; 121: first cavity; 122: second cavity; 13: backpack belt; 131: second buffer airbag; 14: telescopic belt; 15: V-belt; 16: control pull ring; 161: second housing; 162: tension sensor; 163: spring; 164: pull ring; 17: horizontal fixing belt; 18: belt bucket; 181: bucket; 182: connecting ring; 19: telescopic device; 191: first bracket; 192: roller; 193: wound spring; 2: descending device; 21: roller shaft; 22: speed reducing mechanism; 221: second bracket; 222: damper shaft; 2221: second thread groove; 223: speeds sensor; 224: locking mechanism; 2241: first thread groove; 2242: magnet; 225: locking mechanism; 2251: first housing; 2252: electromagnet; 23: annular safety bucket; 3: controller; 31: first battery; 32: help signal transmitter; 4: alarm; 41: third bracket; 42: third housing; 421: warning light; 422: ship type switch; 423: speaker; 424: second battery; 43: hook

### DETAILED DESCRIPTION

The invention is illustrated in accordance with figures. The figures as simplified diagrams demonstrate the basic structures of the apparatus of embodiments of the invention. Thus; the invention is not limited to the figures.

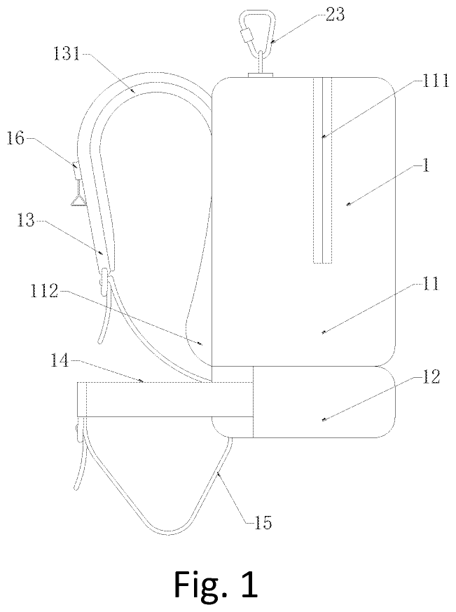

As shown in FIGS. 1, 2, 3, and 4, an intelligent rope descending rescue backpack includes a backpack body 1, a descending device 2, a controller 3 and an alarm 4. The backpack body 1 includes an upper body 11, a lower body 12, a backpack belt 13, a telescopic belt 14 and a V-belt 15. The upper body 11 and the lower body 12 are connected to each other and separated from each other. The inner cavity of the backpack body 1 is provided with a support plate 10 passing through the upper body 11 and the lower body 12.

In an example embodiment, the support plate 10 should be fixedly disposed on the inner wall surface of the side close to the back of the user. In order to better fit the back of the user and increase the comfort, the support plate 10 is a chain plate made of a plurality of connected plates that fit the back of the human body.

The upper body 11 is provided with a zipper 111, and the lower body 12 is divided by a horizontal plate into a first cavity 121 near the user and a second cavity 122 far away from the user. The second cavity 122 is provided with a telescopic device 9. The telescopic belt 14 is divided into two sections. One end of two sections of the telescopic belt 14 is respectively connected with the telescopic device 19. The other ends of the two wound springs 14 are respectively connected to each other through a belt buckle 18.

The V-belt 15 is disposed in the first cavity 121, and one end of the V-belt 15 is connected with the support plate 10, and the other end of the V-belt 15 extends from the first cavity 121 and is interconnected with the belt buckle 18. In order to achieve that the one end of the V-belt 15 protrudes from the first cavity 121 while accommodating most of the V-belt 15 in the first cavity 121, the lower end surface of the first cavity 121 should be made of two pieces of cloth, and the intersection of tow piece of cloth overlap.

In one example embodiment, the V-belt 15 is made of a triangular cloth, one side of which is connected to the support plate 10, and the angle of the side to which the support plate 10 is attached extends from the first cavity 121 and is connected with the belt bucket 18.

In one example embodiment, the V-belt 15 is a triangular mechanism consisting of three straps, wherein the two straps are interconnected with the support plate 10, and the other straps extend from the first cavity 121 and are connected with the belt bucket 18.

The descending device 2 is disposed in the inner cavity of the upper body 11. The descending device 2 includes a roller shaft 21 which is rollingly connected to the support plate 10, a speed reducing mechanism 22 and an annular safety buckle 23. The rope is wound around the roller shaft 21. The rope is wound with the speed reducing mechanism 22 and passes through the backpack body 1 and is connected to the annular safety buckle 23. The rope includes a structure prepared by using a single fiber or a mixture of several fibers (for example, Kevlar fiber mixed with ordinary chemical fiber) or a fiber wrapped with other materials (such as a wire rope wrapped with Kevlar fiber).

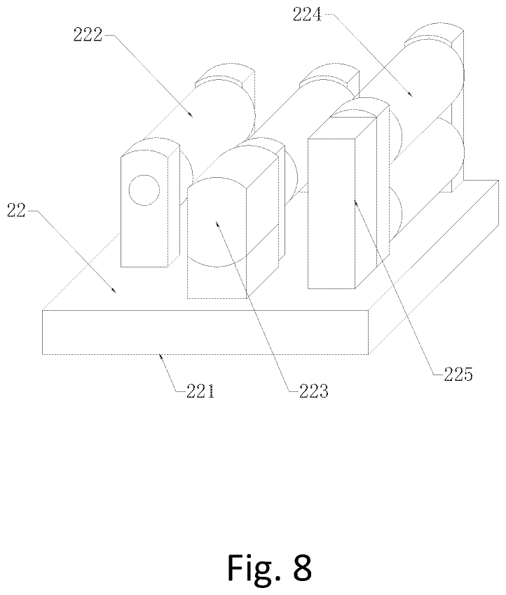

As shown in FIG. 8, the speed reducing mechanism 22 includes a second bracket 221 connected to the support plate 10, a plurality of damper shafts 222 disposed on the second bracket 221, a plurality of locking shafts 224 rotatably coupled to the second bracket 221, and a locking mechanism 225. The locking mechanism 225 includes a first housing 2251, an electromagnet, 2252 a magnet 2242 fixedly coupled to the locking shaft 224. The electromagnet 2252 abuts against an opposite surface of the magnet 2242. When the electromagnet 2252 is energized, it is attached to the magnet 2242 to stop the rotation of the locking shaft 224.

In an example embodiment, in order to prevent the electromagnet 2252 from being attracted to the magnet 2242 without being energized, the locking shaft 224 is locked. The electromagnet 2252 should not be suitable for the magnetizable material such as the armature. The corresponding locking shaft. 224, the first housing 2251 and the second bracket 221 should also be made of a non-magnetizable material.

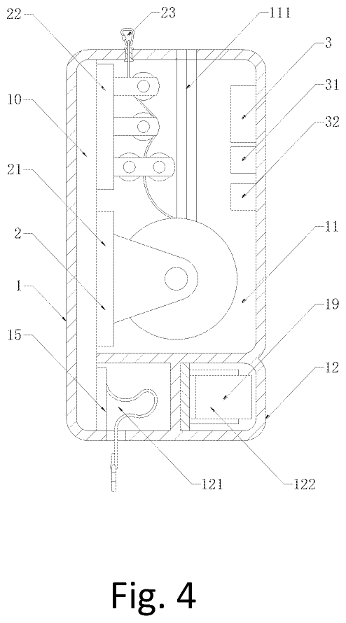

As shown in FIG. 4, the controller 3 and the first battery 31 are disposed in the inner cavity of the upper body 11 and are connected to each other. The controller 3 is further connected with the control pull ring 16 disposed on the backpack belt 13 and the help signal transmitter 32 disposed in the upper body 11.

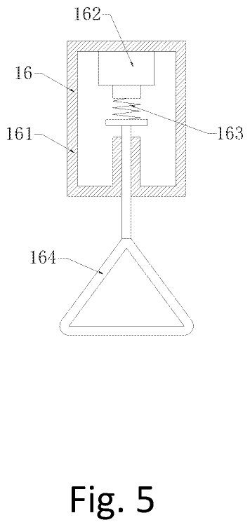

As shown in FIG. 5, the control pull ring 16 includes a second housing 161, a tension sensor 162 disposed in the second housing 161, and pull rings 164 connected to each other by a spring 163 and a tension sensor 162.

The control pull ring 16 is used for controlling the opening and closing of the locking mechanism 225. Specifically, the tension signal is detected by the tension sensor 162, and instructions are sent to the controller 3 to control the energization of the electromagnet 2252. When the electromagnet 2252 is energized, it stops reducing. In the opposite way, it continues descending. Pulling the control pull ring 16 initiates the locking mechanism 225 during the descent (i.e. stopping the descent). When it stops the descent, pulling the control pull ring 16 closes the locking mechanism 225 (i.e. continuing to descend).

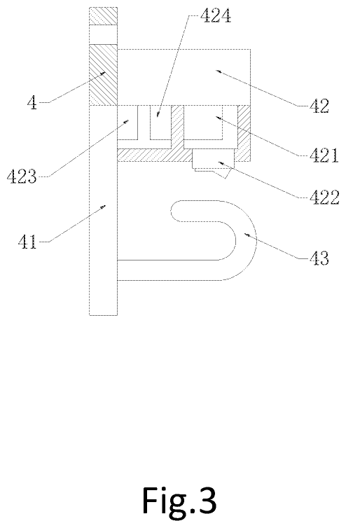

As shown in FIG. 3, the alarm 4 includes a third bracket 41 fixedly disposed at the external, a third housing 42 disposed on the third bracket 41, and a hook 43 having a J-shaped structure disposed on the third bracket 41. The third housing 42 is provided with a ship type switch 422. A warning light 421, a speaker 423 and a second battery 424 connected to the ship type switch 422 are arranged in the three housing 42. The hook 43 is disposed opposite to the ship type switch 422, and the distance between the two is just enough to allow the annular safety buckle 23 to pass. In use, the annular safety buckle 23 toggles the ship type switch 422 when the gap between the hook 43 and the ship type switch 422 is crossed. The warning light 421 and the speaker 423 are turned on to send a signal.

In an example embodiment as shown in FIG. 1, the upper body 11 is provided with a first buffer airbag 112 used to buffer the force from the support plate 10 applied to the back.

In an example embodiment as shown in FIG. 1, a second buffer airbag 131 is fixedly disposed on the inner side of the backpack belt 13, and two ends of the backpack belt 13 are respectively connected with the upper body 11 and the telescopic belt 14. The lower end of the backpack belt 13 is connected to the telescopic belt 14 to fit different body shapes.

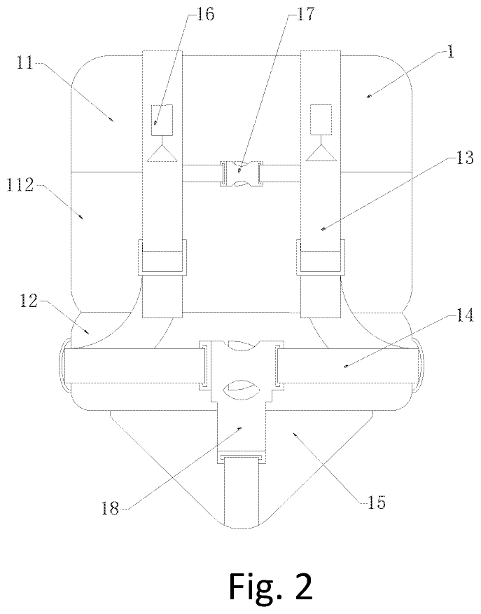

In an example embodiment as shown in FIG. 2, the middle portion of the backpack belt 13 is provided with a horizontal fixing belt 17, and the horizontal fixing belt 17 is provided with a connecting buckle to strength the fixing effect of the backpack belt 13.

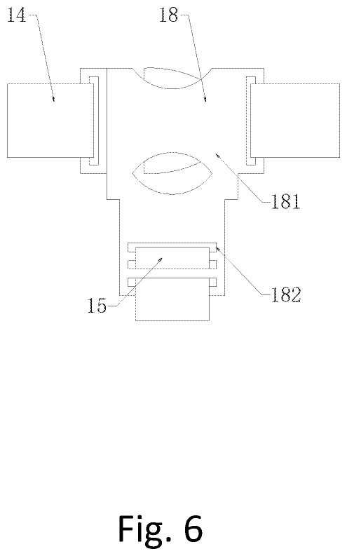

In an example embodiment as shown in FIG. 6, the belt buckle 18 includes a buckle 181 connected to the telescopic belt 14, and a connecting ring 182 is fixedly disposed on the buckle 181.

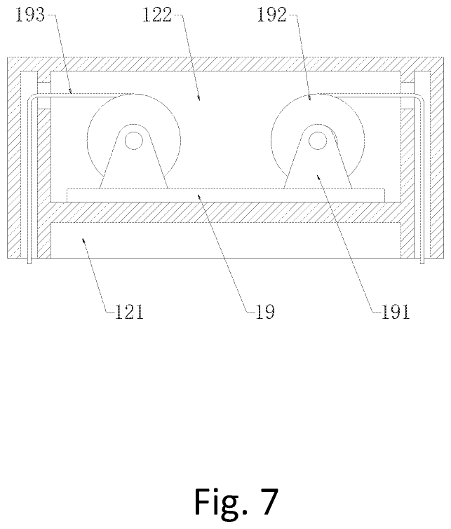

In an example embodiment as shown in FIG. 7, the telescopic device 19 includes a first bracket 191, a roller 192 symmetrically fixed on the first bracket 191, and a wound spring 193 on the roller 192. The wound spring 193 protrudes from two ends of the second cavity 122.

In an example embodiment, the telescopic belt 14 is divided into two sections, one ends of the two sections of the telescopic belt 14 are respectively connected with the wound springs 193 extending from two ends of the second cavity 122, and the other ends of the two wound springs 193 are respectively connected to each other by a belt buckle 18.

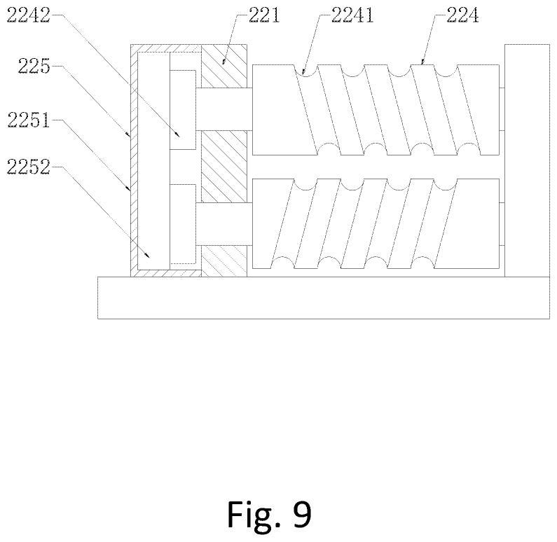

In an example embodiment as shown in FIG. 9, the locking shaft 224 is provided with a first thread groove 2241, and the rope on the roller shaft 21 is wound around the first thread groove 2241.

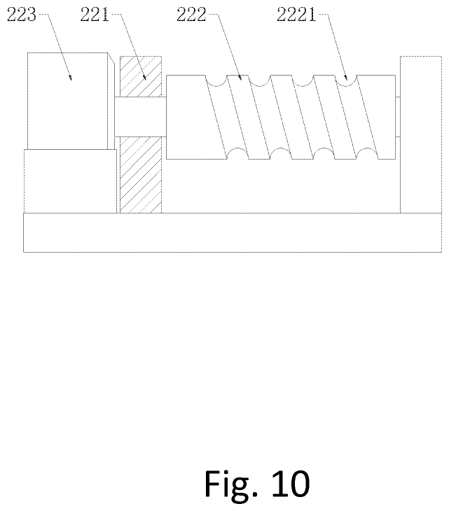

In an example embodiment as shown in FIG. 10, the damper shaft 222 is provided with a second thread groove 2221, and the rope on the roller shaft 21 is sequentially wound around the second thread groove 2221. The descent speed is limited by the damping effect generated by the damper shaft 222.

In an example embodiment as shown in FIG. 10, the damper shaft 222 is connected to a rotational speed sensor 223 fixedly disposed on the second bracket 221.

The controller 3 is electrically connected to the electromagnet 2252, the tension sensor 162 and the rotational speed sensor 223. In one example embodiment, the rotational speed detected by the rotational speed sensor 223 is transmitted back to the controller 3. When the controller determines that the descending speed converted from the rotational speed exceeds the safe range, the electromagnet 2252 is energized, and the locking mechanism 225 is opened to achieve the purpose of deceleration.

The intelligent rope descending rescue backpack of the present invention which has a reasonable structure and includes a backpack body, a descending device, a controller and an alarm. The backpack body is fixed to a human body by a backpack belt, a telescopic belt, a V-belt. The descending device and a controller are disposed in the backpack body. The alarm is fixedly arranged at the external. The descending device is provided with a rope to be safely buckled. The reducing speed is controlled by the rope together with the speed reducing mechanism and the controller. It is safe and reliable. When the safety buckle is connected with the alarm, the warning light and the speaker on the alarm are automatically turned on to remind the rescuers. People's location information is sent to the rescuers by the help signal transmitter to facilitate the rescuers to look for people. The intelligent rope descending rescue backpack has a simple and reasonable structure, easy to use, safe and reliable, highly intelligent, and easy to store, etc. which effectively solves the difficulty of escaping from high-rise buildings.

The exemplary embodiments of the present invention are thus fully described. Although the description referred to particular embodiments; it will be clear to one skilled in the art that the present invention may be practiced with variations of these specific details. Hence this invention should not be construed as limited to the embodiments set forth herein.

1. An intelligent rope descending rescue backpack, comprising: a backpack body 1, a descending device 2, a controller 3 and an alarm 4, wherein the backpack body 1 includes an upper body 11, a lower body 12, a backpack belt 13, a telescopic belt 14 and a V-belt 15; the upper body 11 and the lower body 12 are connected to each other and separated from each other; the inner cavity of the backpack body 1 is provided with a support plate 10 passing through the upper body 11 and the lower body 12,
wherein the upper body 11 is provided with a zipper 111, and the lower body 12 is divided into a first cavity 121 and a second cavity 122; the second cavity 122 is provided with a telescopic device 9; the telescopic belt 14 is divided into two sections; one end of two sections of the telescopic belt 14 is respectively connected with the telescopic device 19; the other ends of the two wound springs 14 are respectively connected to each other through a belt buckle 18; the V-belt 15 is disposed in the first cavity 121, and one end of the V-belt 15 is connected with the support plate 10, and the other end of the V-belt 15 extends from the first cavity 121 and is interconnected with the belt buckle 18,
wherein the descending device 2 is disposed in the inner cavity of the upper body 11; the descending device 2 includes a roller shaft 21 which is rollingly connected to the support plate 10, a speed reducing mechanism 22 and an annular safety buckle 23; the rope is wound around the roller shaft 21; the rope is wound with the speed reducing mechanism 22 and passes through the backpack body 1 and is connected to the annular safety buckle 23,
wherein the speed reducing mechanism 22 includes a second bracket 221 connected to the support plate 10, a plurality of damper shafts 222 disposed on the second bracket 221, a plurality of locking shafts 224 rotatably coupled to the second bracket 221, and a locking mechanism 225; the locking mechanism 225 includes a first housing 2251, an electromagnet, 2252 a magnet 2242 fixedly coupled to the locking shaft 224; the electromagnet 2252 abuts against an opposite surface of the magnet 2242,
wherein the controller 3 and the first battery 31 are disposed in the inner cavity of the upper body 11 and are connected to each other; the controller 3 is further connected with the control pull ring 16 disposed on the backpack belt 13 and the help signal transmitter 32 disposed in the upper body 11; the control pull ring 16 includes a second housing 161, a tension sensor 162 disposed in the second housing 161, and pull rings 164 connected to each other by a spring 163 and a tension sensor 162,
wherein the alarm 4 includes a third bracket 41 fixedly disposed at the external, a third housing 42 disposed on the third bracket 41, and a hook 43 having a J-shaped structure disposed on the third bracket 41; the third housing 42 is provided with a ship type switch 422; a warning light 421, a speaker 423 and a second battery 424 connected to the ship type switch 422 are arranged in the three housing 42.

2. The intelligent rope descending rescue backpack of claim 1, wherein the upper body 11 is provided with a first buffer airbag 112.

3. The intelligent rope descending rescue backpack of claim 1, wherein a second buffer airbag 131 is fixedly disposed on the inner side of the backpack belt 13, and two ends of the backpack belt 13 are respectively connected with the upper body 11 and the telescopic belt 14; the middle portion of the backpack belt 13 is provided with a horizontal fixing belt 17 and the horizontal fixing belt 17 is provided with a connecting buckle.

4. The intelligent rope descending rescue backpack of claim 1, wherein the belt buckle 18 includes a buckle 181 connected to the telescopic belt 14, and a connecting ring 182 is fixedly disposed on the buckle 181.

5. The intelligent rope descending rescue backpack of claim 1, wherein the telescopic device 19 includes a first bracket 191, a roller 192 symmetrically fixed on the first bracket 191, and a wound spring 193 on the roller 192; the wound spring 193 protrudes from two ends of the second cavity 122.

6. The intelligent rope descending rescue backpack of claim 1, wherein the telescopic belt 14 is divided into two sections, one ends of the two sections of the telescopic belt 14 are respectively connected with the wound springs 193, and the other ends of the two wound springs 193 are respectively connected to each other by a belt buckle 18.

7. The intelligent rope descending rescue backpack of claim 1, wherein the damper shaft 222 and the locking shaft 224 are respectively provided with a second thread groove 2221 and a first thread groove 2241, and the rope on the roller shaft 21 is sequentially wound around the first thread groove 2241 and the second thread groove 2221.

8. The intelligent rope descending rescue backpack of claim 1, wherein the damper shaft 222 is connected to a rotational speed sensor 223 fixedly disposed on the second bracket 221.

9. The intelligent rope descending rescue backpack of claim 1, wherein the controller 3 is electrically connected to the electromagnet 2252, the tension sensor 162 and the rotational speed sensor 223.

10. The intelligent rope descending rescue backpack of claim 8, wherein the controller 3 is electrically connected to the electromagnet 2252, the tension sensor 162 and the rotational speed sensor 223.
